(19) United States
(12) Patent Application Publication
(10) Pub. No.: US 2026/0250105 A1
(43) Pub. Date: Aug. 27, 2026

(54) PIPE HANDLING SYSTEM

(71) Applicant: Mark PIACUN, Tallai QLD (AU)

(72) Inventor: Mark PIACUN, Tallai QLD (AU)

(21) Appl. No.: 19/099,557

(22) PCT Filed: Aug. 1, 2023
(86) PCT No.: PCT/AU2023/050718

§ 371 Date: Jan. 29, 2025

(30) Foreign Application Priority Data
Aug. 2, 2022 (AU) 2022902165

(51) Int. Cl. B66C 1/42; B66C 1/62; F16L 1/06

(52) U.S. Cl. CPC B66C 1/42; B66C 1/62; F16L 1/06

(57) ABSTRACT

A device for handling construction material is provided, the device comprising a body portion and a holding portion connected with the body portion. The holding portion or a part thereof is laterally moveable relative to the body portion or a part thereof, to configure the holding portion between a gripping configuration and a releasing configuration. The holding portion or a part thereof is rotatable relative to the body portion or a part thereof. Related systems and methods are further provided.

### FIELD

This invention relates to construction and installation. More particularly, this invention relates (although is not limited) to industrial pipe laying.

### BACKGROUND

Pipe laying is a process by which sections of industrial pipe are aligned and connected to form pipelines. A range of industries require pipeline installation, including oil and gas industries and urban utilities such as water and sewerage.

Pipe may be installed above ground, below ground (in-ground), or under water. Installation techniques vary depending on the type of installation and piping application. However, safe and effective industrial pipe installation requires specific skills and typically involves teams of construction workers with specialised training.

For in-ground pipe installation, pipes are usually installed in trenches. Trench size (width and depth) and shape is selected based on pipe size and installation technique. Generally, once arranged in place in trenches, in-ground piping is at least partially covered with backfill material such as sand, gravel, fine stone, and/or topsoil.

Existing installation techniques for industrial pipe are associated with some significant challenges. One significant challenge is that traditional installation techniques involve construction workers entering trenches to manipulate pipe during installation. Workers in trenches are exposed to substantial danger including injury from moving pipes, and trench cave-in. Additionally, trenches must be sized not only to receive the pipe itself, but also to accommodate and allow safe movement of workers.

Some attempts have been made to develop equipment to reduce manual labour within trenches during pipe installation. For example, some existing equipment has been developed to grip and manoeuvre pipe sections for machine-assisted placement of pipe in trenches. However, existing equipment has at least certain limitations. For example, existing equipment can be associated with significant limitations for accurate and stable control of pipe sections. Additionally, existing equipment can be limited to handling of specific pipe sizes.

Accordingly, there is a need for new approaches for industrial pipe laying. In at least some circumstances, there is a particular need for approaches that can reduce or eliminate manual pipe handling by workers in trenches during industrial pipe laying. It could be particularly desirable, in at least some instances, to develop new approaches allowing for industrial laying of pipe of varying sizes.

### SUMMARY

A first aspect of the invention broadly provides a device for handling construction material, the device comprising a body portion and a holding portion, wherein the holding portion is movably connected with the body portion. Suitably, the device is adapted for installation of industrial pipe.

Suitably, the holding portion of the device of the first aspect is adapted to releasably hold industrial pipe. Suitably, the body portion of the device is adapted to move the holding portion for installation of industrial pipe.

Suitably, the holding portion of the device of the first aspect comprises a plurality of contact surfaces. The contact surfaces of the holding portion may be of pads or plates or the like. In embodiments, the holding portion comprises at least three contact surfaces. In embodiments, the holding portion comprises at least six contact surfaces.

In embodiments, the holding portion of the device of the first aspect comprises a plurality of gripping parts. Suitably, the plurality of contact surfaces of the holding portion are of or attached to the plurality of gripping parts.

The gripping parts of the holding portion of the device of the first aspect may comprise first and second gripping members. In embodiments, the first and second gripping members of the holding portion of the device are of gripping jaws, or the like. In embodiments, the gripping jaws are substantially paired gripping jaws.

In embodiments, at least one of the contact surfaces of the holding portion of the device is of or attached to each of the first and second gripping members, respectively. In embodiments, at least two of the contact surfaces of the holding portion are of or attached to each of the first and second gripping members, respectively.

The holding portion of the device of the first aspect may comprise one or more gripping supports. In embodiments, the holding portion comprises first and second gripping supports.

In embodiments, at least one of the contact surfaces of the holding portion of the device of the first aspect is of or attached to the one or more gripping supports. In embodiments, at least one of the contact surfaces is of or attached to each of the first and second gripping supports.

The gripping supports of the holding portion of the device of the first aspect may be of or attached to the gripping parts of the holding portion. In embodiments, the one or more gripping supports are attached to the first and second gripping members of the gripping parts of the holding portion. In embodiments, the first and/or second gripping members are slidably engaged or engageable with the one or more gripping supports.

Suitably, the holding portion of the device of the first aspect, or one or more of the gripping parts thereof, is configurable between a gripping configuration and a releasing configuration.

In embodiments, one or more of the gripping parts of the holding portion of the device is movable between a gripping configuration, wherein the gripping parts are relatively together; and a releasing configuration, wherein the gripping parts are relatively apart.

In embodiments, the first and/or second gripping members of the holding portion of the device are laterally movable relative to the body portion of the device or a part thereof, between the gripping configuration and the releasing configuration.

The first and/or second gripping members of the holding portion of the device may be laterally movable relative to the one or more gripping supports of the holding portion of the device, between the gripping configuration and the releasing configuration.

In embodiments, the holding portion of the device, or one or more of the gripping parts thereof, is turnable relative to the body portion of the device or a part thereof. The holding portion, or one or more of the gripping parts thereof, may be at least partially rotatable relative to the body portion or a part thereof. In embodiments, the holding portion, or one or more of the gripping parts thereof, is completely rotatable relative to the body portion or a part thereof.

The body portion of the device of the first aspect may comprise a first or lower body part; and a second or upper body part.

In embodiments, the holding portion of the device, or one or more of the gripping parts thereof, is laterally movable relative to the second part of the body portion of the device.

In embodiments, the holding portion of the device, or one or more of the gripping parts thereof, is turnable relative to the second part of the body portion of the device. In embodiments, the holding portion of the device, or one or more of the gripping parts thereof, is at least partially rotatable relative to the second part of the body portion. In embodiments, the holding portion of the device, or one or more of the gripping parts thereof, is completely rotatable relative to the second part of the body portion.

Suitably, the body portion of the device of the first aspect comprises one or more actuators for moving the holding portion of the device, or a part thereof. In embodiments, the one or more actuators comprise hydraulic or pneumatic actuators. In embodiments, the one or more actuators comprise hydraulic actuators.

The body portion of the device may comprise a lateral actuator, for laterally moving the holding portion of the device, or one or more of the gripping parts thereof, relative to the body portion of the device or a part thereof. In embodiments, the lateral actuator is a hydraulic actuator.

In embodiments, the lateral actuator of the body portion of the device comprises, or is connected with, one or more lateral actuation supports of the device. Suitably, the one or more lateral actuation supports connect at least a part of the holding portion of the device, such as one or more of the gripping parts, with the lateral actuator. The one or more lateral actuation supports of the device may be of the first part of the body portion of the device.

In embodiments, the lateral actuator of the body portion of the device is for laterally moving one or more of the gripping parts of the holding portion relative to the second part of the body portion of the device. In embodiments, the lateral actuator is for laterally moving one or more of the gripping parts relative to the second part of the body portion via the lateral actuation supports.

In embodiments, the lateral actuator of the body portion of the device is for laterally moving the first and/or second gripping members of the holding portion relative to the second part of the body portion of the device via the lateral actuation supports.

The body portion of the device of the first aspect may comprise a turning actuator, for turning or rotating the holding portion of the device, or one or more of the gripping parts thereof, relative to the body portion of the device or a part thereof. In embodiments, the turning actuator is a pneumatic or hydraulic actuator. In embodiments, the turning actuator is or comprises a slew drive. In embodiments, the turning actuator is or comprises a hydraulic slew drive.

In embodiments, the turning actuator comprises, or is connected with, one or more turning actuation supports of the device. Suitably, the one or more turning actuation supports connect at least a part of the holding portion of the device, such as one or more of the gripping parts, with the turning actuator. The one or more turning actuation supports of the device may be of the first part of the body portion of the device.

In embodiments, the turning actuator is for turning or rotating one or more of the gripping parts of the holding portion relative to the second part of the body portion of the device, via the turning actuation supports. In embodiments, the turning actuator is for turning or rotating the first and/or second gripping members of the holding portion relative to the second part of the body portion of the device, via the turning actuation supports.

In embodiments, the body portion of the device of the first aspect is adapted for attachment with an excavator arm or the like. The body portion may comprise one or more attachment supports, for attachment with an excavator arm or the like. In embodiments, the one or more attachment supports are of the second part of the body portion of the device.

The device of this aspect may be adjustable for use with construction material of varying sizes. In embodiments, the device is adjustable for use with industrial pipe of varying sizes. In embodiments, the device is adjustable for use with cylindrical pipe of varying circumferences.

In embodiments, the holding portion of the device is adjustable for use with pipe of varying sizes. In embodiments, a relative position and/or configuration of one or more of the gripping parts of the holding portion is adjustable for use of the device with pipe of varying sizes.

In embodiments, a position of the first and/or second gripping members of the holding portion of the device is adjustable for use of the device with pipe of varying sizes. The first and/or second gripping members may be adjustable relative to the body portion of the device, or a part thereof, to adjust a position of the first and/or second gripping members in the gripping configuration and/or the releasing configuration.

In embodiments, the first and/or second gripping members of the holding portion of the device are laterally adjustable relative to the body portion of the device, or a part thereof, to adjust a position of the first and/or second gripping members in the gripping configuration and/or the releasing configuration.

In embodiments, the first and/or second gripping members of the holding portion of the device are vertically adjustable relative to the body portion of the device, or a part thereof, to adjust a position of the first and/or second gripping members in the gripping configuration and/or the releasing configuration.

In embodiments, the first and/or second gripping members of the holding portion of the device of the first aspect are fixable at various positions relative to the body portion of the device, or a part thereof, to adjust a position of the first and/or second gripping members in the gripping configuration and/or the releasing configuration.

The first and/or second gripping members of the holding portion of the device may be fixable at various positions relative to the one or more lateral actuation supports of the body portion of the device, to adjust a position of the first and/or second gripping members in the gripping configuration and/or the releasing configuration.

In embodiments, the one or more lateral actuation supports comprise a plurality of slots or apertures for releasably fixing the first and/or second gripping members of the holding portion of the device with the lateral actuation supports, to adjust a position of the first and/or second gripping members in the gripping configuration and/or the releasing configuration.

Suitably, the plurality of slots or apertures of the lateral actuation supports comprise laterally spaced slots or apertures. In embodiments, the plurality of slots or apertures of the lateral actuation supports comprise vertically spaced slots or apertures.

In embodiments, a position of the one or more gripping supports of the holding portion of the device is adjustable for use of the device with pipe of varying sizes. The first and/or second gripping supports of the holding portion of the device may be adjustable relative to the first and/or second gripping members of the holding portion, for use with pipe of various sizes.

In embodiments, the first and/or second gripping supports of the holding portion of the device are vertically adjustable relative to the first and/or second gripping members of the holding portion, to adjust a position of the first and/or second gripping supports in the gripping configuration and/or the releasing configuration.

In embodiments, the first and/or second gripping supports of the holding portion of the device are laterally adjustable relative to the first and/or second gripping members of the holding portion, to adjust a position of the first and/or second gripping supports in the gripping configuration and/or the releasing configuration.

The first and/or second gripping supports of the holding portion of the device may be fixable at various positions relative to the first and/or second gripping members, to adjust a position of the first and/or second gripping supports in the gripping configuration and/or the releasing configuration.

In embodiments, the first and/or second gripping members of the holding portion of the device comprise a plurality of slots or apertures for releasably fixing the first and/or second gripping supports with the first and/or second gripping members, to adjust a position of the first and/or second gripping supports in the gripping configuration and/or the releasing configuration.

Suitably, the plurality of slots or apertures of the first and/or second gripping members comprise vertically spaced slots or apertures. In embodiments, the plurality of slots or apertures of the first and/or second gripping members comprise laterally spaced slots or apertures.

The holding portion of the device, or one or more of the gripping parts thereof, may be slidably connected with the body portion of the device, or a part thereof, to facilitate adjustment or configuration of the device for use with pipe of varying sizes.

In embodiments, the first and/or second gripping members of the holding portion of the device are slidably engaged with the one or more lateral actuation supports of the body portion of the device, to facilitate lateral adjustment of the first and/or second gripping members relative to the one or more lateral actuation supports, for use with pipe of varying sizes.

The device of the first aspect may comprise one or more sensors. The one or more sensors may be of or connected with the holding portion and/or the body portion of the device. The one or more sensors may be wired or wireless sensors.

In embodiments, the device comprises one or more visual sensors, such as cameras. One or more of the visual sensors may be of or connected with the first part of the body portion of the device. Additionally or alternatively, one or more of the visual sensors may be of or connected with the second part of the body portion of the device.

In embodiments, the device comprises one or more directional sensors. The directional sensors may be or comprise angle sensors, such as shaft-type angle sensors. In embodiments, the device comprises one or more proximity sensors.

One or more of the directional, angle, or proximity sensors of the device of the first aspect may be of or connected with the body of the device, or a part thereof. In embodiments, one or more of the directional, angle, and/or proximity sensors is of or connected with the first part of the body portion of the device. In embodiments, one or more of the directional, angle, and/or proximity sensors is of or connected with the second part of the body portion of the device.

One or more of the directional, angle, and/or proximity sensors of the device may be connected with the holding portion of the device, or one or more of the gripping parts thereof.

In embodiments, the device of the first aspect comprises one or more pressure sensors, such as hydraulic pressure sensors. The one or more pressure sensors may be adapted for sensing force applied by one or more of the gripping parts of the device in a gripping configuration.

Suitably, one or more of pressure sensors of the device is of or connected with the holding portion of the device, or one or more of the gripping parts thereof.

The device of the first aspect may comprise, or be connected or connectable with, one or more controllers.

In embodiments, the device comprises a controller for configuring the holding portion of the device between the gripping configuration and the releasing configuration. In embodiments, the device comprises a controller for turning or rotating the holding portion, or one or more of the gripping parts thereof.

The one or more controllers of the device may comprise one or more actuator controllers, for controlling the one or more actuators of the device. In embodiments, the one or more actuator controllers are hydraulic or pneumatic controllers. In embodiments, the device comprises a hydraulic or pneumatic controller for controlling the lateral actuator of the device. In embodiments, the device comprises a hydraulic or pneumatic controller for controlling the turning actuator of the device.

The device of the first aspect may comprise, or be connected or connectable with, one or more user interfaces. The one or more user interfaces may comprise a screen. In embodiments, the screen of the one or more user interfaces is for displaying data from the one or more sensors of the device.

In embodiments, the one or more controllers and the one or more user interfaces of the device are of a shared controller and user interface component. In embodiments, the shared controller and user interface component is a pendant component, or the like.

In embodiments, the device comprises, or is connected or connectable with, a pendant component comprising one or more actuator controllers, such as the hydraulic or pneumatic controllers for controlling the lateral actuator or turning actuator of the device.

In embodiments, the pendant component of, or connected or connectable with, the device of the first aspect comprises a display, such as an LCD screen or the like.

In embodiments, one or more of the user interfaces of the device is of a separate user interface unit, such as a monitor unit or the like.

In embodiments, the user interface and/or display of the device can display data from the one or more visual sensors of the device, such as images from the one or more cameras. In embodiments, the user interface and/or display of the device can display data from the one or more directional sensors, such as relative angle of the gripping parts from the one or more shaft-type angle sensors. In embodiments, the user interface and/or display of the device can display data from the one or more pressure sensors, such as data on force applied by one or more gripping parts of the device in a gripping configuration.

A second aspect of the invention provides a system comprising the device of the first aspect attached to a pneumatic or hydraulic arm or the like. The pneumatic or hydraulic arm may be an excavator arm, or the like. In embodiments, the pneumatic or hydraulic arm of the system of the second aspect is releasably attached to the body portion of the device of the first aspect. In embodiments, the pneumatic or hydraulic arm is releasably attached to the one or more attachment supports of the upper part of the body portion of the device.

A third aspect of the invention provides construction equipment comprising the device of the first aspect or the system of the second aspect. Suitably, the construction equipment is pneumatic construction equipment or hydraulic construction equipment. In embodiments, the construction equipment is hydraulic construction equipment. In embodiments, the construction equipment is an excavator or the like.

A fourth aspect of the invention provides a method of installing construction material using the device of the first aspect, the system of the second aspect, or the construction equipment of the third aspect, including a step of holding construction material with the holding portion of the device of the first aspect.

Suitably, the step of holding the construction material with the holding portion of the device of the first aspect includes a step of supporting and/or stabilising the construction material against the plurality of contact surfaces of the holding portion of the device.

In embodiments, the step of holding the construction material with the holding portion of the device of the first aspect includes moving one or more of the gripping parts of the holding portion of the device between a releasing configuration and a gripping configuration.

Suitably, the method of the fourth aspect includes a step of releasing the construction material from the holding portion of the device of the first aspect.

In embodiments, the step of releasing the construction material from the holding portion of the device of the first aspect includes moving one or more of the gripping parts of the holding portion of the device between a gripping configuration and a releasing configuration.

The method of the fourth aspect may include a step of orienting the construction material held by the holding portion of the device of the first aspect.

In embodiments, the step of orienting the construction material includes turning or rotating the holding portion, or one or more of the gripping parts thereof, to thereby orient the construction material.

In embodiments, the method of the fourth aspect includes a step of controlling the device of the first aspect with one or more controllers. The one or more controllers may be of or connected with the device of the first aspect, or of or connected with the construction equipment of the third aspect.

In embodiments, the step of controlling the device includes controlling the one or more actuators of the device with the one or more actuator controllers.

In embodiments, the method of the fourth aspect includes a step of sensing a position or orientation of the device of the first aspect or the holding portion thereof and/or or sensing a position or orientation of the construction material held by the device.

In embodiments, the step of sensing the position or orientation includes sensing the position or orientation with the one or more visual sensors, such as cameras.

In embodiments, the step of sensing the position or orientation according to the method of the fourth aspect includes sensing the position or orientation with the one or more angle sensors, such as shaft-type angle sensors.

In embodiments, the method of the fourth aspect includes a step of sensing force or pressure exerted by the holding portion of the device, or one or more of the gripping parts thereof, such as sensing force or pressure exerted by the holding portion of the device, or one or more of the gripping parts thereof, on the construction material.

The method of the fourth aspect may include a step of adjusting the holding portion of the device of the first aspect for use with construction material of a particular size.

In embodiments, the step of adjusting the holding portion of the device includes adjusting the first and/or second gripping members of the holding portion relative to the body portion of the device, to adjust a position of the first and/or second gripping members in the gripping configuration and/or the releasing configuration.

According to embodiments of the method of the fourth aspect, the adjusting of the first and/or second gripping members of the device relative to the body portion of the device may be or include laterally adjusting the first and/or second gripping members, such as laterally adjusting the first and/or second gripping members relative to the lateral actuation supports of the body portion.

In embodiments, the step of adjusting the holding portion of the device according to the method of the fourth aspect includes adjusting the first and/or second gripping supports of the holding portion relative to the first and/or second gripping members of holding portion.

The adjusting of the first and/or second gripping supports relative to the first and/or second gripping members of the holding portion may be or include vertically adjusting the first and/or second gripping supports.

The construction material according to the method of the fourth aspect may be industrial pipe. In embodiments, the construction material is a unit or section of industrial pipe for installation as part of a pipeline.

The step of holding the industrial pipe with the holding portion of the device of the first aspect may include a step of holding a section of industrial pipe at or towards: a substantially central position of the section of industrial pipe; a first end of the section of industrial pipe; or a second end of the section of industrial pipe.

In embodiments, the step of holding the section of industrial pipe with the holding portion includes holding the section of industrial pipe at or towards a first end of the section of industrial pipe, the first end for connection with an end of another section of industrial pipe.

In embodiments, the method of the fourth aspect is a method of in-ground installation of industrial pipe. The method may include a step of installing industrial pipe in a trench.

In embodiments, the method of the fourth aspect is a method of in-ground installation of industrial pipe, including a step of installing industrial pipe in a trench of a width no more than 2× or 1.5× the diameter of the industrial pipe.

### BRIEF DESCRIPTION OF THE DRAWINGS

The invention will be described hereinafter with reference to typical embodiments illustrated in the drawings, wherein:

FIG. 1 sets forth a front perspective view of an embodiment of a device according to an aspect of the invention, in a closed configuration.

FIG. 2 sets forth a rear perspective view of the device of FIG. 1.

FIG. 3 sets forth a front view of the device of FIG. 1.

FIG. 4 sets forth a rear view of the device of FIG. 1.

FIG. 5 sets forth a top view of the device of FIG. 1.

FIG. 6 sets forth a side view of the device of FIG. 1.

FIG. 7 sets forth a front view of the device of FIG. 1 in an open configuration.

FIG. 9 sets forth a top view of the device of FIG. 7.

FIG. 10 sets forth a partially exploded view of the device of FIG. 1.

FIG. 11 sets forth another partially exploded view of the device of FIG. 1.

FIG. 12 sets forth schematic side views of the device of FIG. 1 adjusted to accommodate pipe of varying sizes, in open and closed configurations.

FIG. 13 sets forth a front perspective view of another embodiment of a device according to an aspect of the invention, in a closed configuration.

FIG. 14 sets forth a rear perspective view of the device of FIG. 13.

FIG. 15 sets forth a front view of the device of FIG. 13.

FIG. 16 sets forth a rear view of the device of FIG. 13.

FIG. 17 sets forth a top view of the device of FIG. 13.

FIG. 18 sets forth a side view of the device of FIG. 13.

FIG. 19 sets forth a front view of the device of FIG. 13 in an open configuration.

FIG. 20 sets forth a rear view of the device of FIG. 19.

FIG. 21 sets forth a top view of the device of FIG. 19.

FIG. 22 sets forth a partially exploded view of the device of FIG. 13.

FIG. 23 sets forth another partially exploded view of the device of FIG. 13.

FIG. 24 sets forth schematic side views of the device of FIG. 13 adjusted to accommodate pipe of varying sizes, in closed configurations.

### DETAILED DESCRIPTION

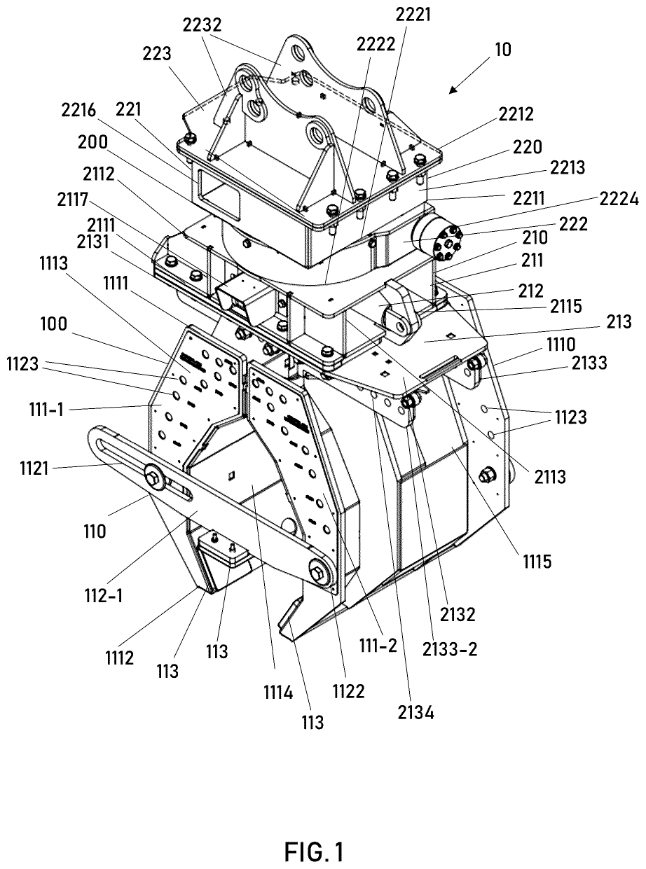

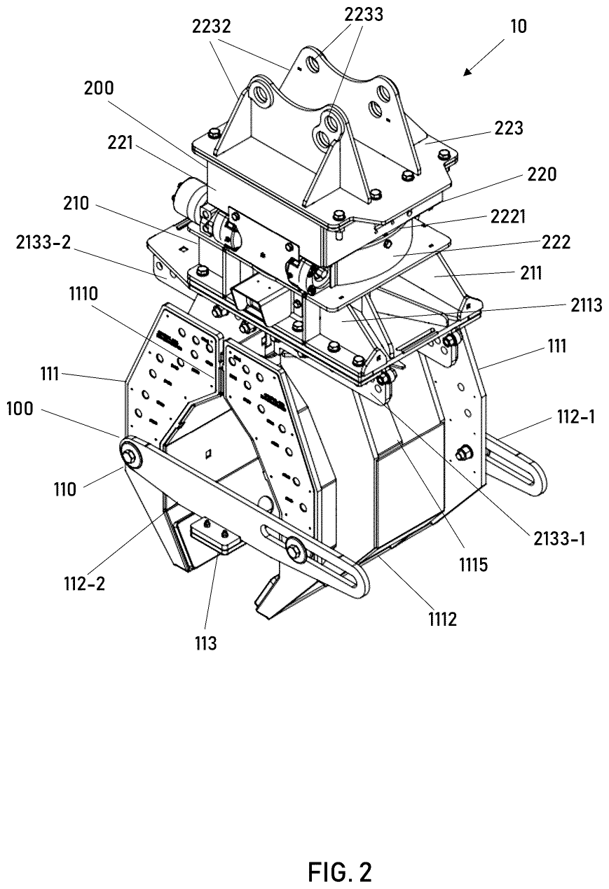

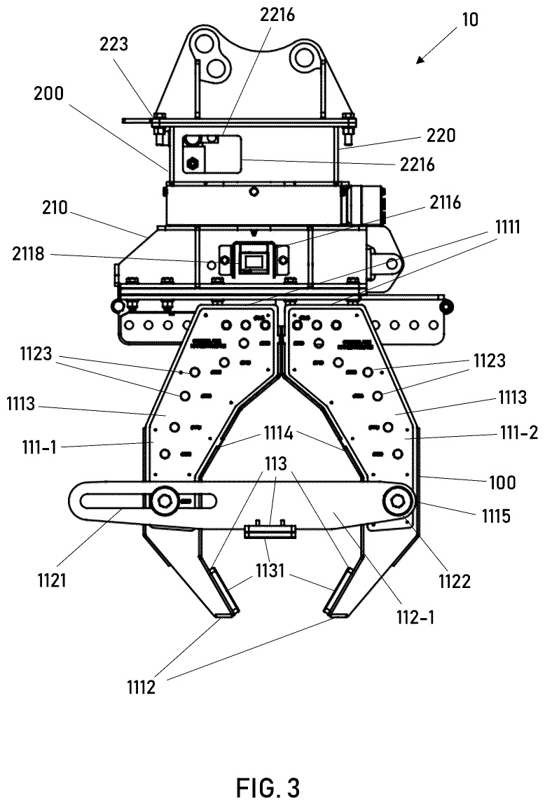

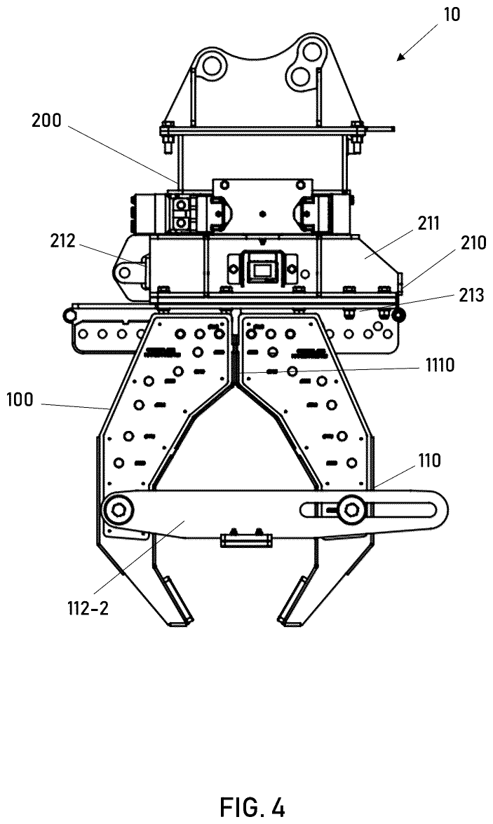

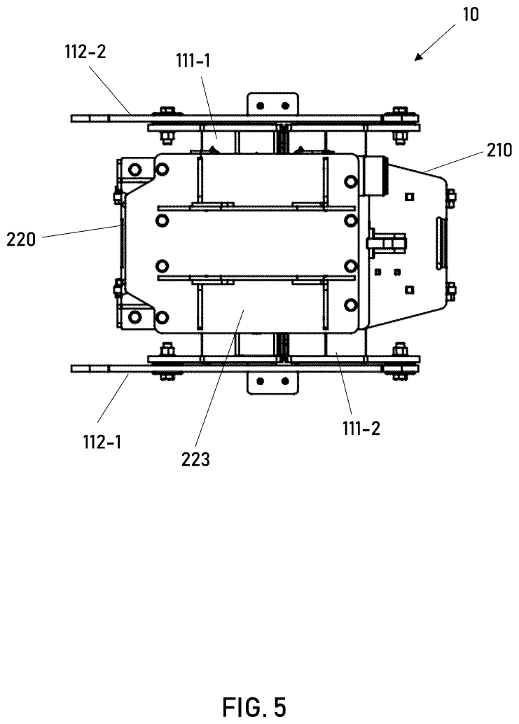

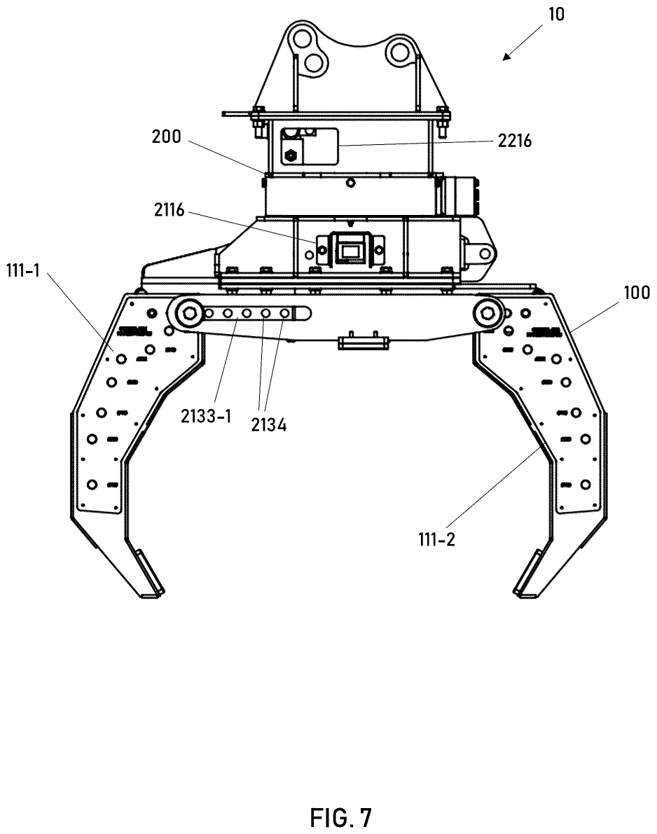

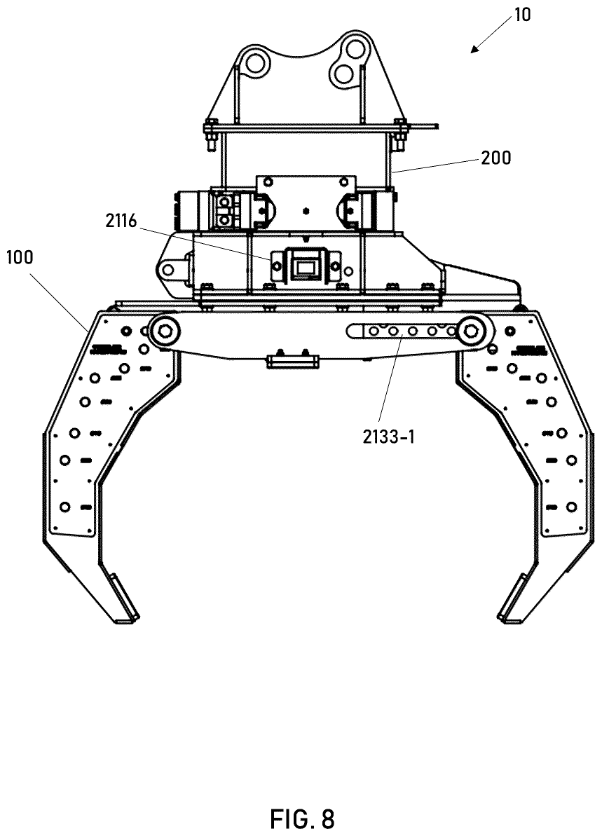

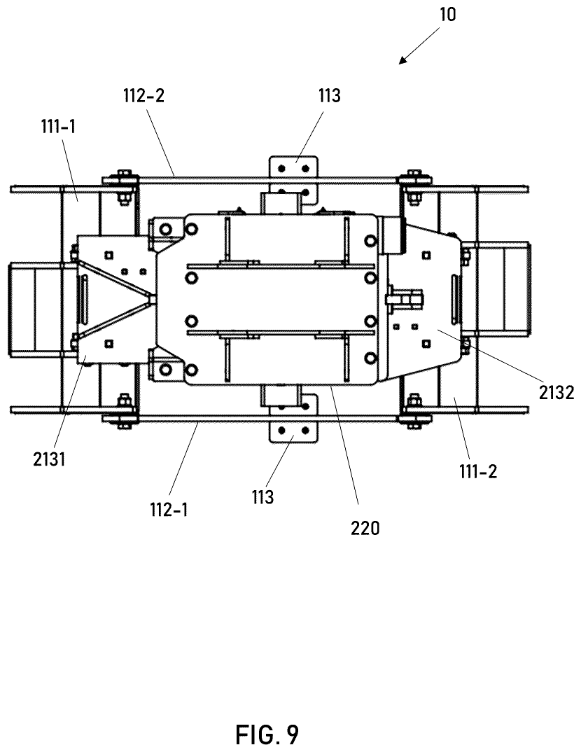

FIGS. 1-11 show an embodiment of a construction material handling device according to an aspect of the invention, device 10. Device 10 comprises holding portion 100 for holding construction material; and body portion 200 for moving holding portion 100. Device 10 is particularly adapted for installation of sections of industrial pipe, although is not limited to this application.

Holding portion 100 of device 10 comprises a plurality of gripping parts 110, adapted for releasably holding industrial pipe.

Gripping parts 110 of holding portion 100 comprise first and second gripping members 111-1 and 111-2. First and second gripping members 111 are paired, substantially arcuate gripping members, which together form gripping jaws 1110.

Each of first and second gripping members 111 comprise proximal end 1111 towards body portion 200; distal end 1112 away from body portion 200; sides 1113 extending between proximal end 1111 and distal end 1112; inner section 1114 extending between sides 1113; and outer section 1115 opposite inner section 1114.

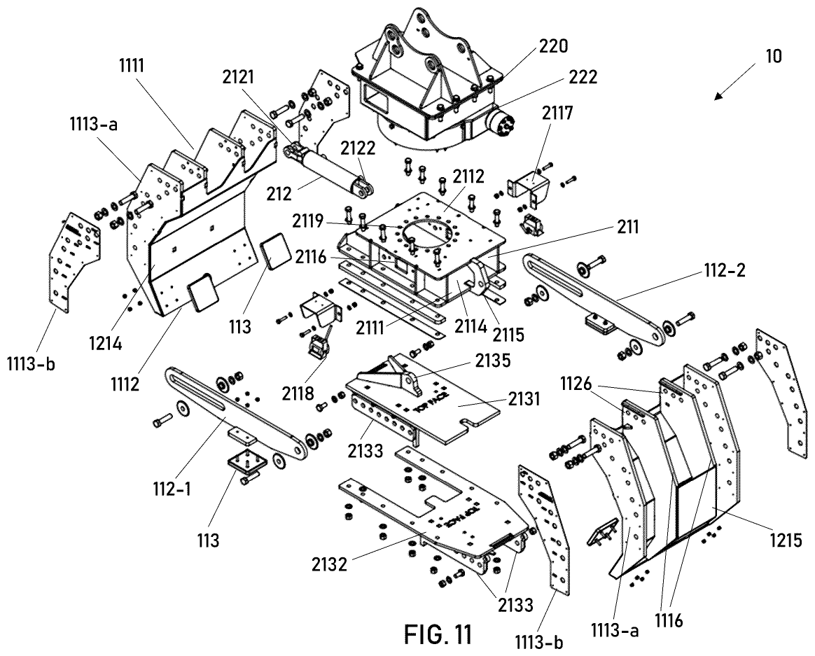

As best seen in FIG. 11, sides 1113 of first and second gripping members 111 are formed from side body 1113-a and side plate 1113-b. Gripping member sides 1113 comprise a plurality of spaced apertures 1123 extending through side body 1113-a and side plate 1113-b.

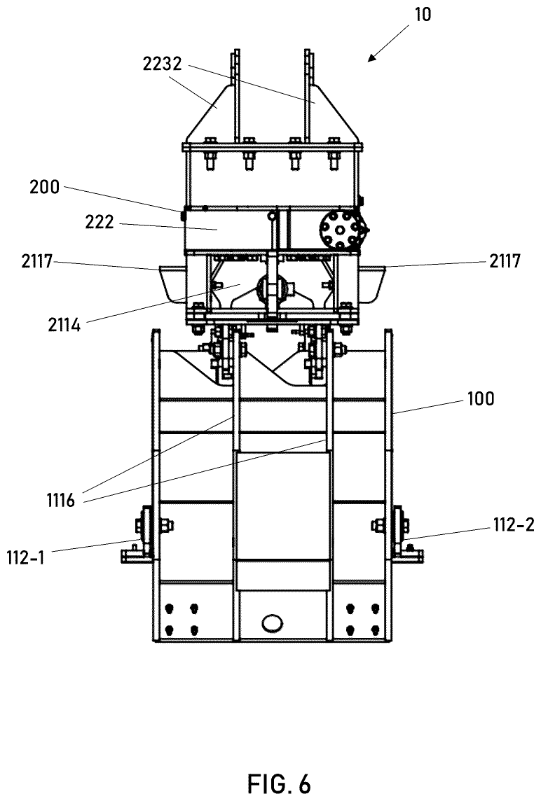

As best seen in FIGS. 6 and 11, each of first and second gripping members 111 further comprise two attachment plates 1116, for attachment of holding portion 100 with body portion 200, as hereinbelow described.

Attachment plates 1116 are of similar structure as side bodies 1113-a and are spaced between and extend parallel with sides 1113 of first and second gripping members 111. Attachment plates 1116 comprise a plurality of spaced apertures 1126 towards proximal end 1111 of gripping members 111.

Gripping parts 110 of holding portion 100 of device 10 further comprise first and second gripping supports 112-1 and 112-2. Gripping supports 112 are elongate supports comprising attachment channel 1121 near to one end; and attachment aperture 1122 near to an opposite end.

Gripping supports 112 of holding device 100 are adjustably attached to sides 1113 of first and second gripping members 111. For attachment of each of first and second gripping supports 112 to sides 1113, a bolt extends through attachment channel 1121 of gripping support 112 and an aperture 1123 of corresponding side 1113 of first gripping member 111; and a bolt extends through attachment aperture 1122 of gripping support 112 and an aperture 1123 of corresponding side 1113 of second gripping member 1110.

Gripping parts 110 of holding portion 100 of device 10 further comprise six contact pads 113. Contact pads 113 comprise resiliently deformable contact surfaces 1131, for contact with construction material, such as industrial pipe, held by gripping parts 110.

Two contact pads 113 of gripping parts 110 are attached against inner section 1114 of each of first and second gripping members 111, at positions adjacent distal end 1112 and respective sides 1113 of gripping members 111.

One contact pad 113 of gripping parts 110 is attached to each of first and second gripping supports 112-1 and 112-2 between attachment channel 1121 and attachment aperture 1122. Each contact pad 113 is perpendicularly attached to an edge of gripping support 112 away from body portion 200.

Body portion 200 of device 10 comprises first part 210 towards holding portion 100; and second part 220 away from holding portion 100.

First part 210 of body portion 200 is adapted for laterally moving holding portion 100, as hereinbelow described. First part 210 comprises frame 211; lateral actuator 212; and lateral actuation support 213.

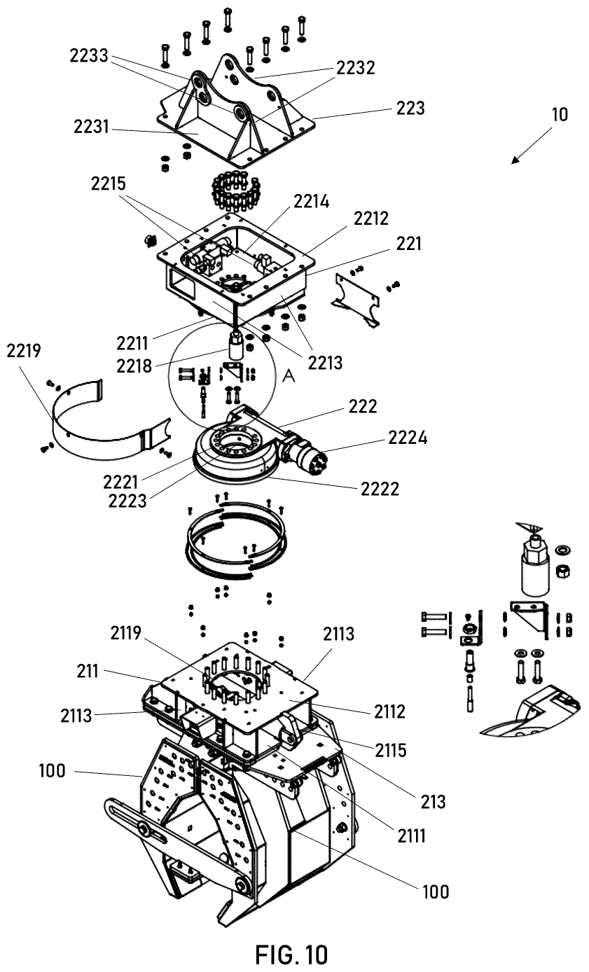

As best seen in FIGS. 10 and 11, frame 211 of first part 210 of body portion 200 comprises distal frame plate 2111 towards holding portion 100; proximal frame plate 2112 away from holding portion 100; frame sides 2113 extending between distal plate 2111 and proximal plate 2112; and inner space 2114 bordered by distal plate 2111, proximal plate 2112, and sides 2113.

Frame 211 further comprises actuator mount 2115 in the form of an arcuate flange extending between distal plate 2111 and proximal plate 2112, the arcuate flange comprising an aperture.

As best seen in FIGS. 10 and 11, proximal plate 2112 of frame 211 comprises central opening 2119. Central opening 2119 allows for connection of components in inner space 2114 of frame 211, such as lateral actuator 212 and angle sensor(s) 2120 as hereinbelow described, with components from second body 220, such as control and/or interfacing components 2215 as hereinbelow described.

Sides 2113 of frame 211 comprise respective sensor openings 2116 into inner space 2114 of frame 211; and sensor shields 2117 extending away from inner space 2114 of frame 211. Visual sensors 2118 (typically wireless video cameras) are installed within inner space 2114 aligned with sensor openings 2116 and shielded by sensor shields 2117.

One or more angle sensors 2120 (not shown), such as shaft-type angle sensors, are typically installed within inner space 2114 of frame 211.

Lateral actuation support 213 of first part 210 of body portion 200 comprises first lateral actuation support plate 2131; and second lateral actuation support plate 2132. Second plate 2132 of lateral actuation support 213 is attached to distal plate 2111 of frame 211. First plate 2131 of lateral actuation support 213 is slidably engaged with distal plate 2111 of frame 211 and second plate 2132.

First plate 2131 and second plate 2132 of lateral actuation support 213 comprise jaw mounts 2133-1 and 2133-2. Jaw mounts 2133 are paired, elongated mounts near to respective edges of first plate 2131 and second plate 2132. Jaw mounts 2133 are perpendicularly attached to plates 2131 and 2132, at surfaces towards holding portion 100. Jaw mounts 2133 comprise respective pluralities of spaced apertures 2134.

Gripping jaws 1110 of gripping parts 110 of holding portion 100 are adjustably attached to lateral actuation support 213 of first part 210 of body portion 200. More particularly, first and second gripping members 111-1 and 111-2 of gripping jaws 1110 are slidably and fastenably attached to jaw mounts 2133-1 and 2133-2, respectively.

For slidable attachment of gripping members 111, attachment plates 1116 of first gripping member 111-1 slidably engage with jaw mounts of 2133-1 of first lateral actuation support plate 2131 in a catch and slot arrangement; and attachment plates 1116 of second gripping member 111-2 slidably engage with jaw mounts 2133-2 of second lateral support plate 2132 in a catch and slot arrangement.

For fastenable attachment of gripping jaws 1110, bolts extend through apertures 1126 of attachment plates 1116 of first gripping member 111-1 and apertures 2134 of jaw mounts 2133-1 of first lateral actuation support plate 2131; and bolts extend through apertures 1126 of attachment plates 1116 of second gripping member 111-2 and apertures 2134 of jaw mounts 2133-2 of second lateral actuation support plate 2132.

As seen in FIG. 11, first plate 2131 of lateral actuation support 213 further comprises actuator mount 2135 in the form of a braced flange extending from first plate 2131 away from holding portion 100, the braced flange comprising an aperture.

As seen in FIG. 11, lateral actuator 212 of first part 210 of body portion 200 is a hydraulic actuator comprising first end 2121; and second end 2122. Lateral actuator 212 extends across inner space 2114 of frame 211 of first part 210 of body portion 200, parallel to sides 2113. First lateral actuator end 2121 is attached to actuator mount 2135 of lateral actuation support 213. Second lateral actuator end 2122 is attached to actuator mount 2115 of frame 211.

Second part 220 of body portion 200 of device 10 is adapted for rotatably moving holding portion 100 of device 10, as hereinbelow described. Second part 220 of body portion 210 comprises frame 221; rotatable actuator 222; and attachment support 223.

As seen in FIG. 10, frame 221 of second part 220 of body portion 200 comprises distal plate 2211 towards holding portion 100; proximal rim 2212 away from holding portion 100; sides 2213 extending between distal plate 2211 and proximal rim 2212; and inner space 2214 bordered by distal plate 2211, proximal rim 2212, and sides 2213.

As seen in FIG. 10, control and interfacing components 2215 are located within inner space 2214 of frame 221. Control components 2215 typically comprise actuator control components, such as solanoids. Interfacing components 2215 typically comprise sensor interfacing components.

One side 2213 of second part frame 221 comprises opening 2216 into inner space 2214. Side opening 2216 facilitates access to and/or connection with control and interfacing components 2215 within inner space 2214.

As seen in FIG. 10, rotatable actuator 222 of second part 220 of body portion 200 is in the form of a slew drive actuator, comprising top plate 2221; base 2222; central channel 2223; and drive 2224.

Top plate 2221 of rotatable actuator 222 is fixed with distal plate 2211 of frame 221 of second part 220 of body portion 200. Base 2222 of rotatable actuator 222 is fixed with proximal plate 2112 of first part 210 of body portion 200. Central channel 2223 of rotatable actuator 222 facilitates connection between inner space 2114 of frame 211 of first part 210 of body portion 200, and inner space 2214 of frame 221 of second part 220 of body portion 200.

Attachment support 223 of second part 220 of body portion 200 comprises plate 2231; and first and second walls 2232.

Attachment support plate 2231 is fastened to proximal rim 2212 of frame 221 of second part 220 of body portion 200.

First and second attachment support walls 2232 are braced walls perpendicularly mounted to support plate 2231 away from holding portion 100. First and second support walls 2232 comprise apertures 2233, for engagement with an excavator arm or the like. It will be appreciated that attachment support 223, and apertures 2233 of support walls 2232 thereof, is in the form of an excavator ‘quick coupler’ component as are known in the art.

As hereinabove described, device 10 typically comprises an angle sensor, such as a shaft-type angle sensor, within inner space 2114. Device 10 may comprise additional directional and/or proximity sensors at one or more other suitable locations of body portion 200 or holding portion 100.

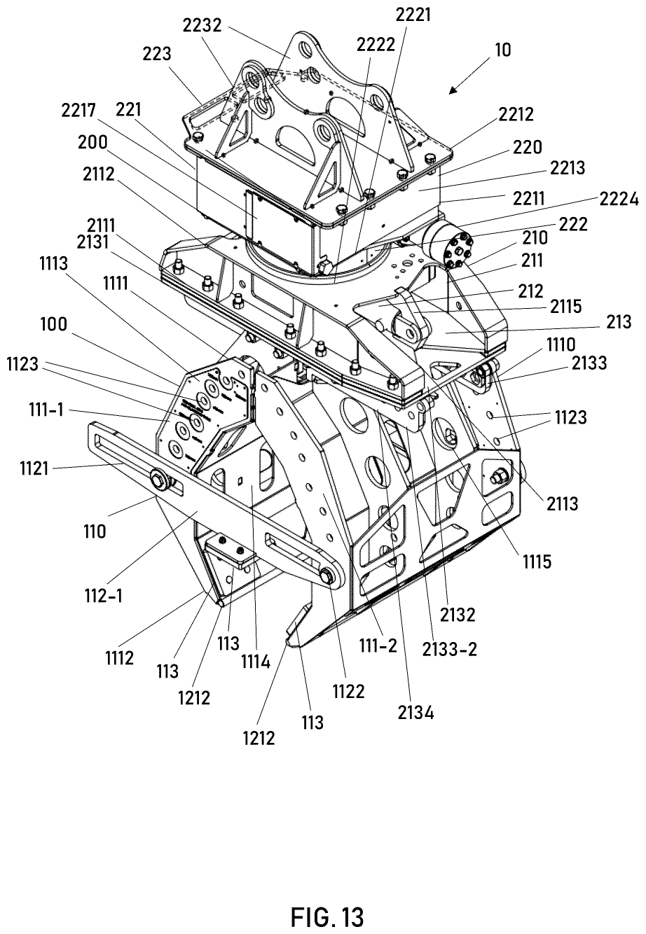

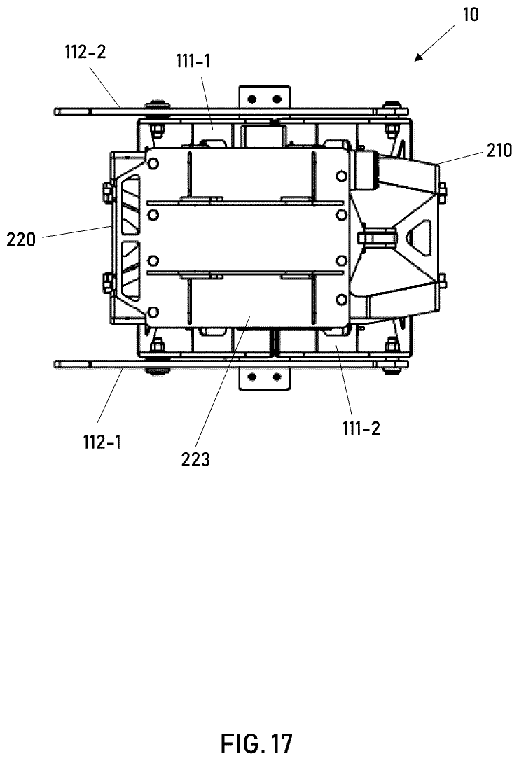

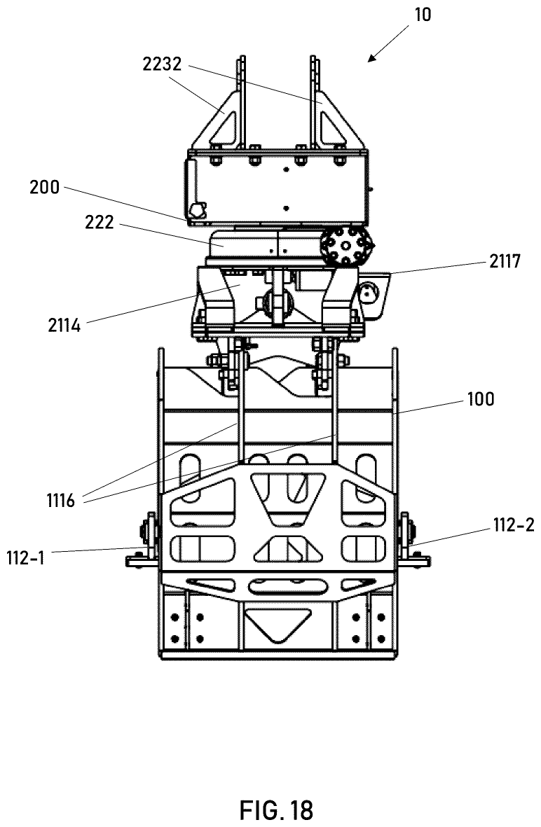

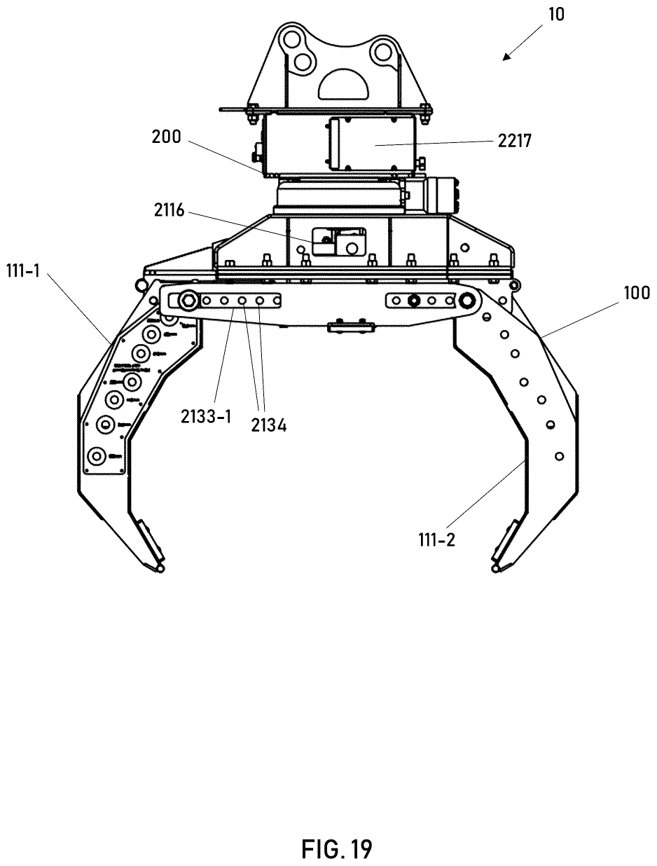

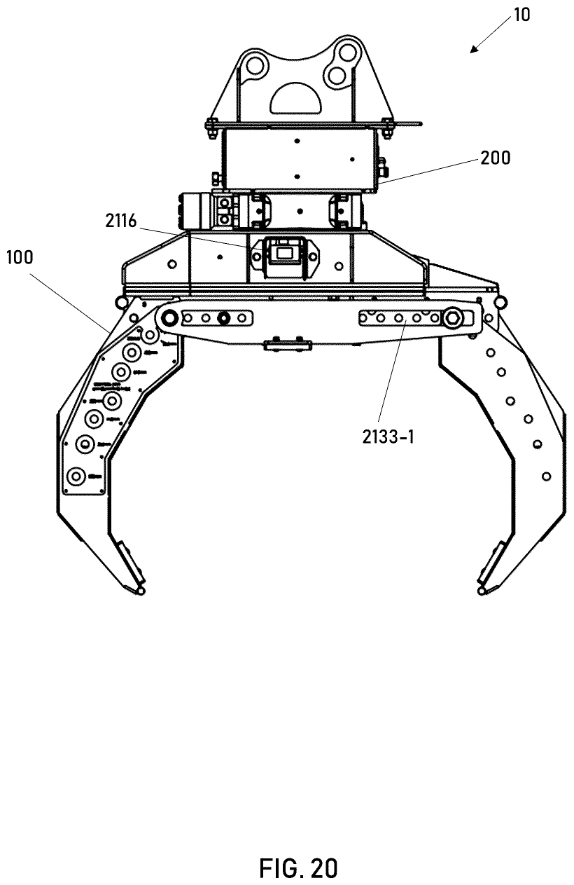

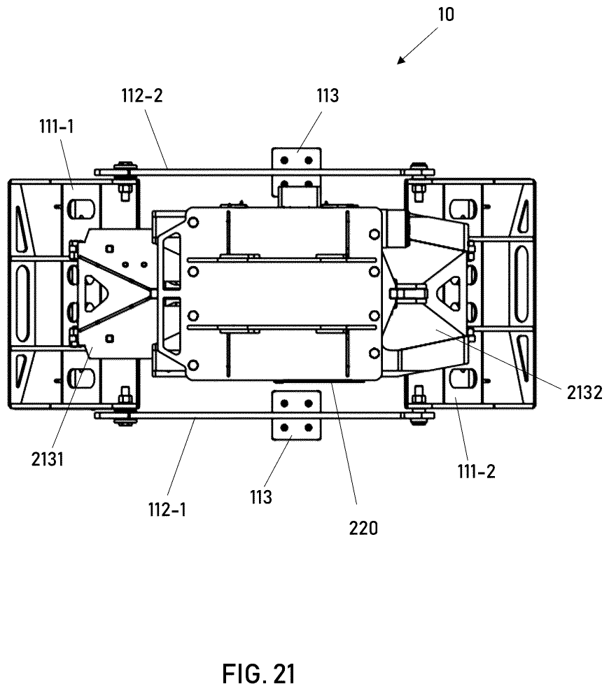

FIGS. 13-23 show another embodiment of device 10.

To distinguish between embodiments of device 10 shown in FIGS. 1-11 and 13-23, respectively, and components thereof, the suffixes ‘A’ and ‘B’ may be used. That is, the embodiment shown in FIGS. 1-11 may be referred to as device 10A (comprising components 100A and 200A, etc.); and the embodiment shown in FIGS. 13-23 may be referred to as device 10B (comprising components 100B and 200B, etc.).

Device 10B is substantially similar to device 10A. However, certain notable differences are described as follows.

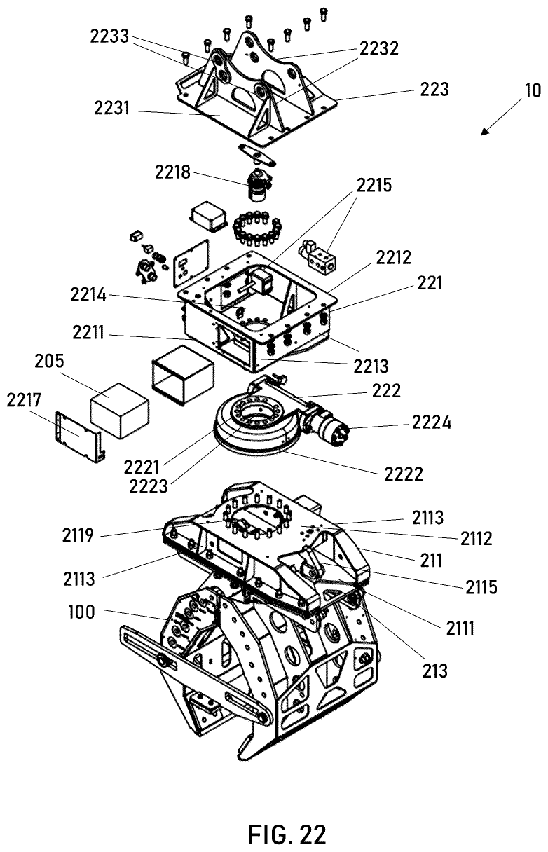

As seen in FIG. 10 and FIG. 22, respectively, device 10A and device 10B comprise respective hydraulic slip rings 2218 (2218A and 2218B, respectively). Slip rings 2218 facilitate transfer of power and signal within body portion 200 of device 10. More particularly, slip rings 2218 facilitate transfer of power and signal from components within inner space 2214 of frame 221 of second part 220 of body portion 200, to rotatable actuator 222 of second part 220 and components within inner space 2114 of frame 211 of first part 210 of body portion 200, wherein frame 211 of first part 210 of body portion 200 is rotatable relative to frame 221 of second part 220 of body portion 200 via rotatable actuator 222.

Notably, slip ring 2218A of device 10A is located outside inner space 2214 of frame 221 of second part 220 of body portion 200, adjacent distal plate 2211 of frame 221, whereas slip ring 2218B of device 10B is located within inner space 2214 of frame 221. Location of slip ring 2218 within inner space 2214 may be preferred to constrain damage to slip ring 2218 such as by contact with environmental material (grit, dirt, grime, etc.) during use of device 10. In embodiments, such as device 10A, wherein slip ring 2218 is located outside inner space 2214, a guard may be fitted to constrain contact of slip ring 2218 with environmental material, such as slip ring guard 2219 connectable with actuator 222 as best seen in FIG. 10.

As hereinabove described, typical embodiments of device 10 comprise electrical and hydraulic components. It will be appreciated that electrical components of device 10 may be powered in any suitable manner, including by wired connection with an excavator or the like with which device 10 is connected, and/or by battery of or connected with device 10.

Notably, device 10B is adapted to receive a rechargeable battery, such as lithium battery 205. As seen in FIG. 22, lithium battery 205 is received within inner space 2214 of device 10B via opening 2216 of frame 221 of second part 220 of body portion 200. Device 10B comprises fastenable door 2217 for opening 2216. Use of a rechargeable battery to power electrical components of device 10 may be preferred to avoid the need for electrical connection of device 10 to an external power source such as an excavator or the like.

Notably, device 10B is adapted for wireless signal communication between a controller and the device, as hereinbelow described. Device 10B suitably comprises one or more wireless signal components as are known in the art, for receiving and/or transmitting signal.

As hereinabove described, typical embodiments of device 10 comprise gripping members 111 comprising distal ends 1112.

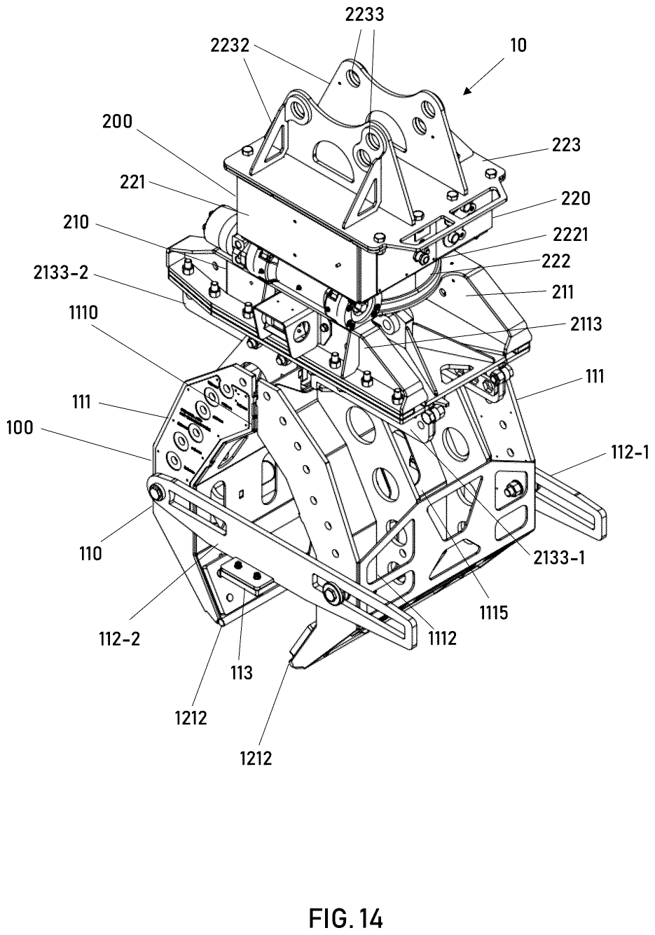

Notably, device 10B comprises distal end guards 1212. As seen in FIG. 13 and FIG. 14, distal end guards 1212 are elongated and cylindrical, extending between sides 1113 of gripping members 111 at tips of distal ends 1112. Inclusion of distal end guards 1212 may be preferred to constrain damage to contact pads 113 near to distal ends 1112 of gripping members 111. In particular, inclusion of distal end guards may prevent or constrain lifting of contact pads 113 away from inner section 1114 of gripping members during handling of pipe sections or the like.

As hereinabove described, typical embodiments of device 10 comprise first and second gripping supports 112 comprising attachment channel 1121 and attachment aperture 1122.

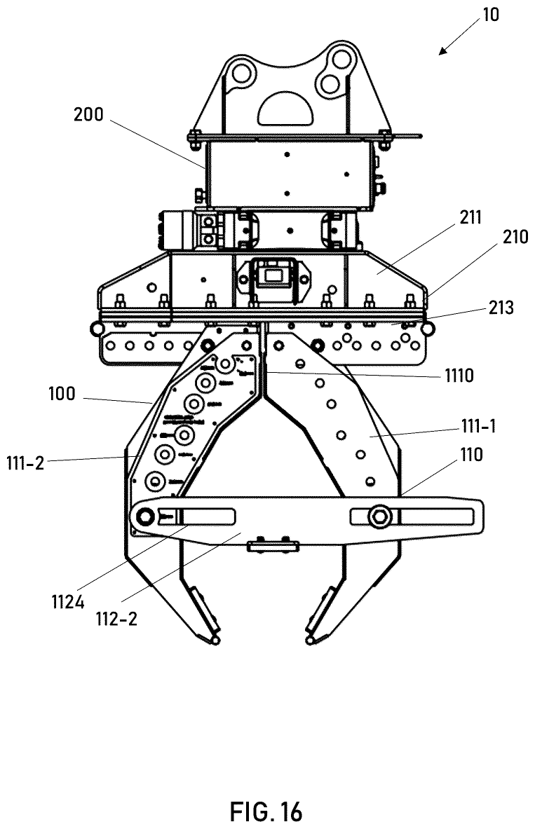

Notably, gripping supports 112 of device 10B comprise viewing channel 1124. Inclusion of viewing channel 1124 may be preferred to allow for viewing of parameters or settings inscribed on side plates 1113-b, such as can be seen in FIG. 16.

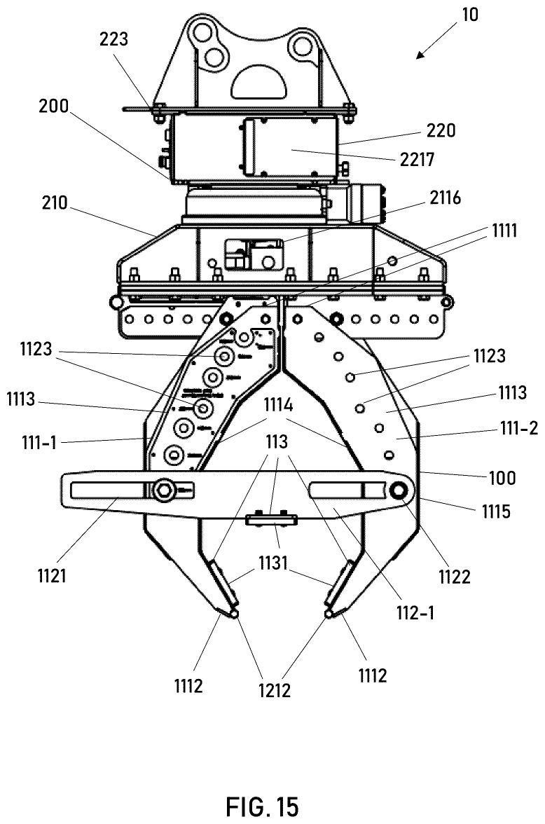

Notably, inclusion of viewing channel 1124 can allow for one side plate 1113-b of the same shape and inscription to be used for front and rear faces of holding portion 100. FIG. 15 shows a front view of device 10B, wherein side plate 1113-b is visible on first gripping member 111-1. FIG. 16 shows a rear view of device 10B, wherein side plate 1113-b is visible on second gripping member 111-2. It will be appreciated that inclusion of viewing channel 1124 allows for inscription on side plate 1113-b on second gripping member 111-2 to be viewed therethrough on the rear face of holding portion 100 shown in FIG. 16.

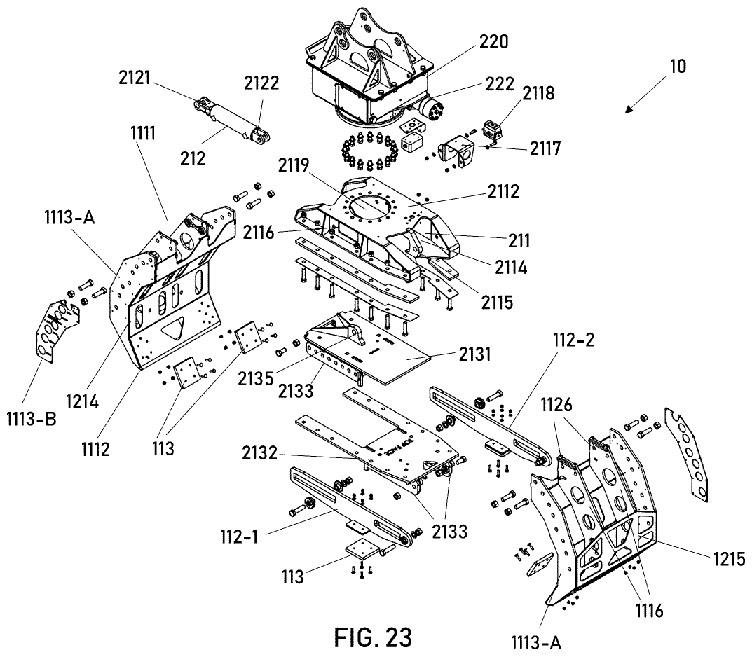

It is also notable that certain components of device 10B are adapted to be relatively lighter as compared to corresponding components of device 10A, while maintaining adequate structural strength, resilience, and/or stability. In particular, with reference to FIG. 23 and FIG. 11, certain components of holding portion 100B of device 10B, such as outer section brace 1215; central inner section face 1214; and attachment plates 1116 of gripping members 111, comprise structural apertures.

It will be understood that any appropriate materials can be used for construction of device 10. Holding portion 100 and body portion 200 are typically constructed, at least primarily, from steel. Resiliently deformable contact surfaces 1131 of contact pads 113 typically comprise natural or synthetic rubber or the like. Where present, distal end guards 1212 are typically resiliently deformable and may comprise natural or synthetic rubber or the like.

It is typically preferred that device 10 has a total weight of less than about 600 kilograms (kg), more preferably less than about 500 kg. In some typical embodiments, total weight of device 10 is between about 300 and about 500 kilograms, including about: 325; 350; 375; 400; 425; 450; and 475 kg. In some typical embodiments total weight of device 10 is about 400 kg or about 450 kg.

In use, device 10 is typically connected with an excavator or the like.

To connect device 10 with an excavator, an excavator arm is attached with attachment support 223 of second part 220 of body portion 200. A quick release excavator coupling arrangement, as are known in the art, is typically used for attachment of the excavator arm with apertures 2233 of attachment support walls 2232 of attachment support 223.

Typically, hydraulic components of the excavator are connected with device 10 via hydraulic hoses extending along the excavator arm. The hydraulic components of the excavator are typically connected with rotatable actuator 222 and lateral actuator 212 of device 10, typically via control and interfacing components 2215 and/or slip ring 2218.

Typically, controller and user interface components are connected with device 10, for control and monitoring of device 10 by an operator of the excavator. The controller and user interface components are typically connected with control and interfacing components 2215 and/or slip ring 2218.

In some embodiments, such as typical device 10A embodiments, the controller and user interface components are connected via wired connection, such as via electrical cabling extending along the excavator arm.

In some embodiments, such as typical device 10B embodiments, the controller and user interface components are connected via wireless connection, such as via the one or more wireless signal components of device 10B.

A cable comprising quick connect plugs, as are known in the art, may be used to facilitate connection of hydraulic components and, optionally (such as for typical device 10A embodiments) controller and user interface components with device 10.

The controller and user interface components connected with device 10 may be of or comprise a pendant controller and/or a screen or monitor of, or installed in, the excavator with which device 10 is connected. In some typical embodiments, the controller and user interface components are of a pendant control comprising a screen. In some typical embodiments, the controller and user interface components are of a pendant control and one or more separate monitors.

In use, when device 10 is connected with an excavator or the like and under control by the controller, holding portion 100 can be configured between a gripping configuration wherein first and second gripping members 111 are relatively together, and a releasing configuration wherein first and second gripping members 111 are relatively apart.

In the gripping configuration, lateral actuator 212 of device 10 is relatively contracted, wherein first end 2121 of lateral actuator 212 is relatively towards second end 2122 of lateral actuator 212.

In the releasing configuration, lateral actuator 212 of device 10 is relatively extended, wherein first end 2121 of lateral actuator 212 is relatively away from second end 2122 of lateral actuator 212.

In use, to configure holding portion 100 of device 10 between the gripping configuration and the releasing configuration, applicable operation of the controller, (such as the pendant control) contracts or extends lateral actuator 212, which slides first plate 2131 of lateral actuation support 213 relative to second plate 2132 of lateral actuation support 213 and distal plate 2111 of frame 211, wherein first gripping member 111-1 attached to jaw mounts 2133-1 of first plate 2131 moves towards (gripping configuration) or away (releasing configuration) from second gripping member 111-2 attached to jaw mounts 2133-2 of second plate 2132.

In use, when first gripping member 111-1 moves towards (gripping configuration) or away (releasing configuration) from second gripping member 111-2, first gripping member 111-1 slides against gripping supports 112, with the bolt extending through attachment channel 1121 of each gripping support 112 and respective aperture 1123 sliding along channel 1121.

In use, when at least typical embodiments of device 10 are connected with an excavator or the like, holding portion 100 can be completely rotated in both rotational directions.

In use, to rotate holding portion 100 of device 10, applicable operation of the controller component of the excavator connected to device 10 activates slew drive actuator 222 of device 10, which rotates first part 210 of body 200 relative to second part 220 of body 200, wherein holding portion 100 rotates with first part 210 of body 200. It will be appreciated that slip ring 2218 facilitates hydraulic and electrical connection between second part 220 of body 200, first part 210 of body 200, and holding portion 100, in the presence of complete rotation of first body part 210 and holding portion 100 relative to second body part 220.

When connected with an excavator or the like, device 10 is typically used for in-ground installation of industrial pipe. Typically, device 10 connected to an excavator or the like is used for placement and connection of individual sections of industrial pipe within a trench.

Advantageously, an excavator can initially be used to dig the trench for in-ground installation of the industrial pipe, then the same excavator used for installation of the pipe using device 10, by exchange of an excavator bucket with device 10 from connection with the excavator arm such as using quick release excavator coupling arrangement as hereinabove described.

Any suitable industrial pipe may be installed using device 10. Device 10 is particularly adapted for handling of relatively heavy and rigid pipe, such as concrete pipe or the like. However, device 10 may also be used for more deformable or malleable pipe, such as plastic pipe, as discussed further hereinbelow.

Typically, to obtain a section of industrial pipe for installation within a trench using device 10 connected with an excavator, holding portion 100 of device 10 is initially configured in a releasing configuration and positioned around the pipe, then holding portion 100 is configured to a gripping configuration to contact the pipe.

More particularly, when holding portion 100 is configured to the gripping configuration to contact the pipe, resiliently deformable contact surfaces 1131 of contact pads 113 are brought into stable contact with respective portions of the surface of the pipe. With the pipe stably held against contact surface 1131 of contact pads 113 in holding portion 100 of device 10, the excavator can be used to move the pipe towards the trench for installation.

For positioning and orientation of the pipe held by holding portion 100 of device 10 within the trench, holding portion 100 can be rotated using the controller component of the excavator as hereinabove described, in addition to standard manoeuvring of the excavator arm as is well-known in the art. The ability to rotate holding portion 100 while the pipe is stably held therein advantageously facilitates installation of pipe within the trench without the need for entry of workers into the trench for manual guidance of the pipe.

Positioning, orientation, and installation of the pipe, including insertion into previously laid pipe sections for modular pipeline construction, is further assisted by cameras 2118, angle sensors 2120, and (optionally) other directional and/or proximity sensors. Typically, video from camera 2118, directional information including angle of orientation from angle sensor 2120 and, optionally, proximity information from proximity sensor(s) is displayed on a screen, such as a screen of a pendant controller and/or one or more other monitors of or installed in the excavator connected to device 10, as hereinabove described.

Advantageously, in use, holding portion 100 can be adjusted to accommodate pipes of varying size.

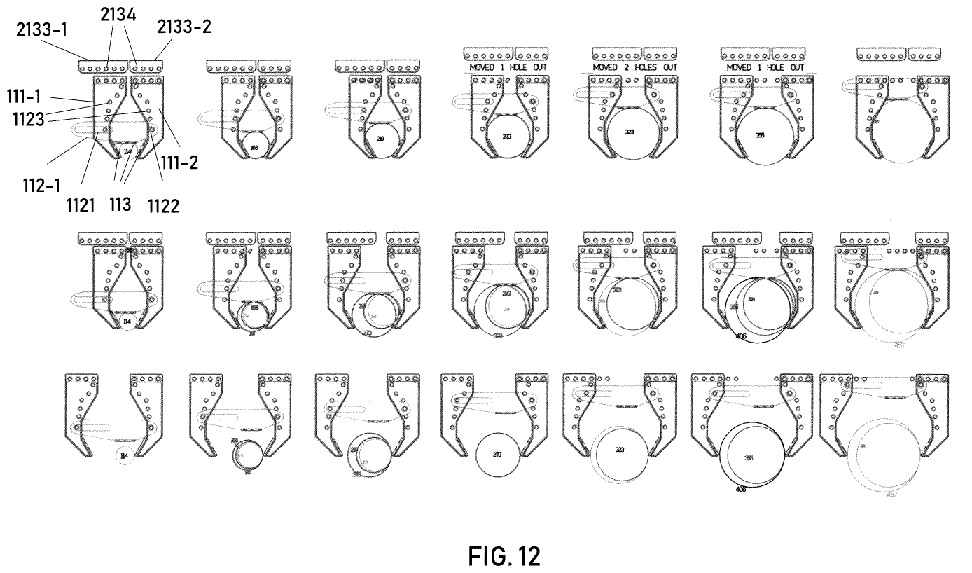

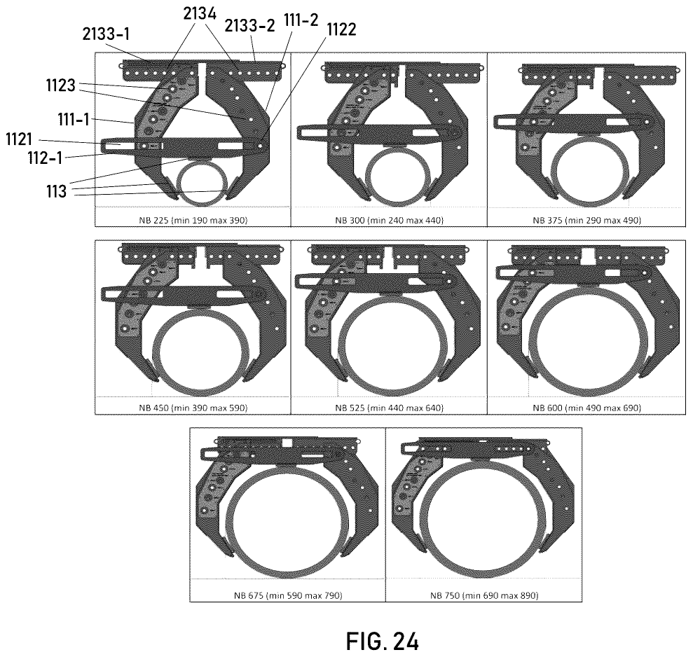

FIG. 12 and FIG. 24 depict adjustment of holding portion 100 of device 10A and device 10B, respectively, to accommodate cylindrical pipe of varying circumferences in gripping and releasing configurations.

With reference to FIG. 12 and FIG. 24, it will be appreciated that adjustment of holding portion to accommodate pipe of varying sizes is achieved, in use, by one or both of:
(a) laterally adjusting the position of attachment of first gripping member 111-1 with jaw mounts 2133-1 of first lateral actuation support plate 2131, and/or adjusting the position of attachment of second gripping member 111-2 with jaw mounts 2133-2 of second lateral actuation support plate 2132; and
(b) vertically adjusting the position of attachment of first gripping support 112-1 and second gripping support 112-2 with sides 1113 of first gripping member 111-1 and second gripping member 111-2.

To laterally adjust the position of attachment of gripping members 111 with jaw mounts 2133, first gripping member 111-1 and/or second gripping member 111-2 is initially unfastened from attachment with the respective jaw mounts 2133 by removal of the bolts from apertures 1126 of attachment plates 1116 and respective apertures 2134 of jaw mounts 2133.

First gripping member 111-1 and/or second gripping member 111-2 are subsequently adjusted relative to respective jaw mounts 2133 by lateral sliding in the catch and slot arrangement as hereinabove described against first lateral actuation support plate 2131 or second lateral actuation support plate 2132, respectively, and re-fastening in the desired adjusted position by replacement of the bolts through apertures 1126 of attachment plates 1116 and apertures 2134 of respective jaw mounts 2133.

With reference to FIG. 12 and FIG. 24, it will be appreciated that lateral adjustment of the position of attachment of first gripping member 111-1 and/or second gripping member 111-2 with jaw mounts 2133 adjusts proximity of respective contact pads 113 attached to gripping members 111 and supports 112, to accommodate pipes of varying circumferences in gripping and releasing configurations.

To vertically adjust the position of attachment gripping supports 112 with sides 1113 of first gripping member 111-1 and second gripping member 111-2, gripping supports 112 are initially unfastened from attachment with respective sides 1113 of gripping members 111 by removal of bolts from attachment channel 1121 and attachment aperture 1122 of gripping supports 112 and respective apertures 1123 of sides 1113 of gripping members 111.

Gripping supports 112 are subsequently adjusted relative to respective sides 1113 by manually raising or lowering gripping supports 112 relative to sides 1113, and re-fastening in the desired adjusted position by replacement of bolts through attachment channel 1121 and attachment aperture 1122 of gripping supports 112 and respective apertures 1123 of sides 1113 of gripping members 111.

With reference to FIG. 12 and FIG. 24, it will be appreciated that vertical adjustment of the position of attachment of gripping supports 112 with sides 1113 adjusts the proximity of respective contact pads 113 attach to supports 112 and gripping members 111, to accommodate pipes of varying circumferences in gripping and releasing configurations.

In typical use for placement and connection of individual sections of industrial pipe within a trench, a section of industrial pipe held using device 10 is inserted into another section of industrial pipe within the trench, with a first end of the section of industrial pipe held using device 10 inserted into a second end of the other section of industrial pipe within the trench. As will be understood to the person skilled in the art, a sealing ring is typically fitted to the first end of the section of industrial pipe held using device 10 to be inserted into the second end of the other section of industrial pipe within the trench.

For pipe insertion as described, it may be desirable to hold the section of industrial pipe using device 10 at a position near to the first end of the industrial pipe. Holding of industrial pipe using device 10 near to the first end of the industrial pipe can be advantageous for precise movement of the first end of the industrial pipe to assist with neat insertion of the first end of the industrial pipe held using device 10 into the second end of the other section of industrial pipe within the trench, including to correctly install the sealing ring. Holding of industrial pipe using device 10 near to the first end of the industrial pipe can be advantageous to allow for viewing of the first end of the industrial pipe and the second end of the other section of industrial pipe within the trench with camera 2118 during insertion of the first end into the second end.

It will be further appreciated that one or more pipe lasers, as are known in the art, may be used to assist with installation of sections of industrial pipe using device 10 as herein described.

Reference to certain advantages of aspects and embodiments of the invention have been made herein, by way of non-limiting example. A summary of certain advantages of at least some typical embodiments of the invention, such as device 10 described in detail herein, is provided as follows although without limitation.

Device 10 allows for industrial pipe to be efficiently and effectively gripped, manoeuvred, and released using an excavator or the like. Holding portion 100 of device 10 can be completely rotated in two opposite directions, facilitated by slew drive actuator 222 and hydraulic slip ring 2218. When combined with typical range of motion of excavator arms, device 10 allows for advantageous control of movement of pipe without the need for manual guidance.

In the gripping configuration, holding portion 100 of device 10 is adapted to stabilise cylindrical pipe at three spaced longitudinal positions around the pipe circumference. Two contact pads 113 of gripping parts 110 of holding portion 100 are spaced along each longitudinal position, for a total of six contact positions. This arrangement is advantageous for stable holding of cylindrical pipe during installation. Advantageously, device 10 exhibits sufficient strength and stability to hold a section of industrial pipe near to a first end thereof, which can be advantageous for insertion of the first end into a second end of another section of industrial pipe as hereinabove described.

Holding portion 100 is adjustable to stably grip pipe of varying circumferences. This advantageously allows for the same device 10 to be used for installation of different sizes of industrial pipe.

Device 10 allows for in-ground installation of pipe without the need for workers to enter trenches. This can offer advantages for worker safety and can reduce labour requirements. Additionally, this can reduce the required size of trenches for installation. Typically, during use of device 10 for in-ground pipe installation, trenches need only be able to accommodate pipe and the holding portion 100 of device 10 allowing for some limited additional room for adjustment. This can reduce or eliminate the need for wide, sloping trenches and/or shoring of trenches, and limit ground disturbance. Advantageously, in typical embodiments, use of device 10 for in-ground installation of a section of pipe requires a trench width of no more than 3×, 2.5×, 2×, or 1.5× a diameter of the section of pipe.

First part 210 of body portion 200 of device 10 rotates with holding portion 100, and comprises sensors including cameras 2118, angle sensor 2120, and (optionally) additional directional and/or proximity sensors. Advantageously, these sensors are rotationally moved in conjunction with rotation of holding portion 100, allowing for effective monitoring of pipe held by holding portion 100. Rotation of cameras 2118 in conjunction with holding portion 100, in particular, can advantageously allow for visualisation during insertion of pipe held in holding portion 100 with another pipe section in previously installed in a trench.

Device 10 is adapted to be used with one or more screens of or installed in an excavator or the like connected to device 10 for display of sensor information, such as a screen of a pendant controller and/or one or more monitors. Advantageously, video from cameras 2118 and angle information from angle sensor 2120 can be displayed on the one or more screens, assisting with pipe installation.

Device 10 can comprise one or more hydraulic pressure sensors for sensing force applied by one or more of the gripping parts of the device, such as gripping members 111 and or gripping supports 112, in a gripping configuration. Advantageously, this can allow for device 10 to be more effectively used with pipes that are prone to deformation, such as plastic pipes.

As hereinabove described, typical embodiments of device 10B may have one or more benefits or advantages.

Device 10B comprises slip ring 2218B located within inner space 2214 of frame 221. Location of slip ring 2218B within inner space 2214 can be advantageous to constrain damage to slip ring 2218B such as damage occurring by contact with dirt and grime etc.

Device 10B is adapted to receive a rechargeable battery and is adapted for wireless signalling between controller and user interface components and device 10B. Operation of device 10B using the rechargeable battery and/or wireless signalling between controller and user interface components can be advantageous to reduce or minimise cabling, such as electrical cabling, extending between device 10B and machinery, such as an excavator, to which device 10B is connected.

Device 10B comprises distal end guards 1212 attached to distal ends 1112 of gripping members 111. Distal end guards 1212 can be advantageous to constrain damage to contact pads 113 near to distal ends 1112, such as lifting of contact pads 113 away from inner section 1114 of gripping members during handling of pipe sections or the like.

Device 10B comprises gripping supports 112 comprising viewing channel 1124. Viewing channel 1124 can be advantageous to allow for viewing of parameters or settings inscribed on side plates 1113-b of gripping members 111.

Device 10B comprises certain components, such as outer section brace 1215, central inner section face 1214, and attachment plates 1116 of holding portion 100, comprising structural apertures. Components such as outer section brace 1215, central inner section face 1214, and attachment plates 1116 comprising structural apertures can be advantageous to reduce weight of device 10B while maintaining adequate structural strength, reliance, and/or stability of device 10B.

It will be understood generally that the above description of embodiments of the invention is provided for purposes of description to one of ordinary skill in the related art. It is not intended to be exhaustive or to limit the invention to a single disclosed embodiment. In some instances, well-known components and/or processes have not been described in detail, so as not to obscure the embodiments described herein.

As described, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations that have been discussed herein, and other embodiments that fall within the spirit and scope of the invention.

It is noted, as one specific example, that devices as described herein may be modified to include one or more components for supporting deformable or bendable pipe sections, such as plastic pipe sections. The one or more components for supporting deformable or bendable pipe sections may suitably be connected to the holding portion of the device, such as the gripping members of the holding portion, wherein a deformable or bendable pipe section held by the holding portion is supported thereagainst or otherwise therewith.

In this specification, the use of the terms “suitable” and “suitably”, and similar terms, is not to be read as implying that a feature or step is essential, although such features or steps may well be preferred.

In this specification, the indefinite articles “a” and “an” are not to be read as singular indefinite articles or as otherwise excluding more than one or more than a single subject to which the indefinite article refers. For example, “a” support includes one support, one or more supports, and a plurality of supports.

In this specification, the terms “comprises”, “comprising”, “includes”, “including”, and similar terms, are intended to denote the inclusion of a stated integer or integers, but not necessarily the exclusion of another integer or other integers, depending on context. That is, a device, system, or method, etc., that comprises or includes stated integer(s) need not have those integer(s) solely, and may well have at least some other integers not stated, depending on context.

In this specification, the terms “consisting essentially of” and “consists essentially of” are intended to mean a non-exclusive inclusion only to the extent that, if additional elements are included beyond those elements recited, the additional elements do not materially alter basic and novel characteristics. That is, a device, system, or method that “consists essentially of” one or more recited elements includes those elements only, or those elements and any additional elements that do not materially alter the basic and novel characteristics of the apparatus, system, or method.

In this specification, terms such as “above” and “below”; “front” and “back”; “top” and “bottom”; “left” and “right”; “horizontal” and “vertical”, and the like, may be used for descriptive purposes. However, it will be understood that embodiments can potentially be arranged in various orientations, and that such relative terms are not limiting and may be interchangeable in appropriate circumstances.

In this specification, unless the context requires otherwise, the terms “connection”, “connected”, “connecting”, and the like, are not to be read as limited to direct connections and may also include indirect connections. For example, unless the context requires otherwise, a stated first component “connected” with a stated second component may be connected via, through, or by, one or more unstated components.

1. A device for handling industrial pipe, the device comprising a body portion and a holding portion connected with the body portion, the holding portion comprising at least three or at least six contact surfaces, wherein:
the holding portion or a part thereof is laterally moveable relative to the body portion or a part thereof, to configure the holding portion between a gripping configuration for stably gripping industrial pipe using the at least three or at least six contact surfaces and a releasing configuration for releasing industrial pipe; and
the holding portion or a part thereof is rotatable relative to the body portion or a part thereof for maneuvering of industrial pipe stably gripped by the holding portion.

2.-3. (canceled)

4. The device of claim 1, wherein the contact surfaces of the holding portion are of at least three or at least six contact pads or contact plates.

5. The device of claim 1, wherein the holding portion comprises a plurality of gripping parts, wherein the at least three or at least six contact surfaces are of the plurality of gripping parts.

6. The device of claim 5, wherein the gripping parts comprise:
first and second gripping members, such as of substantially paired gripping jaws; and
one or more gripping supports, such as first and second gripping supports. engaged with the first and second gripping members.

7.-12. (canceled)

13. The device of claim 6, wherein the first and second gripping members are slidably engaged with the one or more gripping supports.

14. (canceled)

15. The device of claim 6, wherein the first and/or second gripping members of the holding portion are laterally movable, such as laterally slidable, relative to the body portion or part thereof, between the gripping configuration and the releasing configuration.

16. The device of claim 6, wherein the first and/or second gripping members are slidable relative to the one or more gripping supports of the holding portion, between the gripping configuration and the releasing configuration.

17. The device of claim 1, wherein the body portion of the device comprises a first or lower body part; and a second or upper body part, wherein:
the holding portion or a part thereof is laterally movably relative to the second or upper body part; and
the holding portion or a part thereof is rotatable relative to the second or upper body part.

18.-19. (canceled)

20. The device of claim 17, wherein the device comprises:
a lateral actuator for laterally moving the holding portion of the device or part thereof, relative to the body portion of the device or part thereof; and
a turning actuator for rotating the holding portion of the device or part thereof, relative to the body portion of the device or part thereof.

21. (canceled)

22. The device of claim 20, wherein the lateral actuator and the turning actuator are pneumatic actuators or hydraulic actuators.

23. The device of claim 1, wherein the body portion of the device comprises one or more attachment supports, for attachment with a mechanical arm, such as a pneumatic or hydraulic arm.

24. The device of claim 1, wherein the holding portion of the device is adjustable for use with pipe of varying sizes.

25. The device of claim 6, wherein:
the first and/or second gripping members are laterally adjustable relative to the body portion or a part thereof; and
the one or more gripping supports are vertically adjustable and, optionally. laterally adjustable, relative to the first and second gripping members,
for use of the device with pipe of varying sizes.

26.-31. (canceled)

32. The device of claim 1, comprising one or more sensors including:
one or more cameras for imaging during handling of industrial pipe using the device; and/or
one or more angle sensors for sensing of angular orientation during handling of industrial pipe using the device.

33.-38. (canceled)

39. The device of claim 1, wherein the device comprises or is connected with a controller operable to:
configure the holding portion of the device between the gripping configuration and the releasing configuration; and
rotate the holding portion of the device or part thereof relative to the body portion of the device or part thereof.

40.-41. (canceled)

42. The device of claim 32, wherein the device comprises or is connected with a user interface for displaying data, such as video data or angular orientation date, from the more sensors.

43. (canceled)

44. A system comprising the device of claim 1 connected to a mechanical arm, such as a pneumatic or hydraulic arm, optionally wherein the mechanical arm is of a construction vehicle such as an excavator.

45.-46. (canceled)

47. A method of installing industrial pipe using the device of claim 1, including steps of:
configuring the holding portion to the gripping configuration to stably hold a section of industrial pipe; and
rotating the holding portion or part thereof to manoeuvre the section of industrial pipe.

48.-57. (canceled)

58. The method of claim 47, including a step of adjusting the holding portion of the device for a particular size of the section of industrial pipe.
